(19) United States
(12) Patent Application Publication
(10) Pub. No.: US 2016/0094302 A1
(43) Pub. Date: Mar. 31, 2016

(54) MEDIA PLAYBACK DEVICE AND METHOD FOR PREPARING A PLAYBACK OF VARIOUS MEDIA

(71) Applicant: VOLKSWAGEN AG, Wolfsburg (DE)

(72) Inventors: Eva BERNER, Braunschweig (DE); Martin GRADE, Wolfsburg (DE); Manuel JOACHIM, Braunschweig (DE)

(21) Appl. No.: 14/866,133

(22) Filed: Sep. 25, 2015

(30) Foreign Application Priority Data
Sep. 25, 2014 (DE) 10 2014 219 484.9

(51) Int. Cl. H04H 60/52; H04H 60/16; H04H 60/37; H04H 60/46; H04H 60/40; H04H 60/33; G06F 3/16; H04H 60/47

(52) U.S. Cl. CPC H04H 60/52; G06F 3/167; H04H 60/16; H04H 60/47; H04H 60/46; H04H 60/40; H04H 60/33; H04H 60/372

(57) ABSTRACT

A media playback device, a manner of transport and a method for preparing a playback of different media. The method includes receiving a first user input for predefining a first time period for the playback of first media content having first characteristics and receiving a second user input for predefining an automatic playback of second media content having second characteristics following an expiry of the first time period.

### PRIORITY CLAIM

This patent application claims priority to German Patent Application No. 10 2014 219 484.9, filed 25 Sep. 2014, the disclosure of which is incorporated herein by reference in its entirety.

### SUMMARY

Illustrative embodiments relate to a media playback device and a method for preparing a playback of different media. In particular, the illustrative embodiments relate to improvements in the implementation of user wishes in the consumption of different media content over time.

### BACKGROUND

Users of media during participation in road traffic usually have specific preferences and listening habits relating to the media content that they listen to on a specific route. This may involve, for example, the following temporal sequence: 1. Traffic information, 2. News, 3. Comedy programs, 4. Live radio program, or 5. Talking books/longer reports/background reports. The specific sequence of media content is often repeated on a daily basis. For example, the user wishes for a corresponding playback sequence on the daily route to work.

In the prior art, radio alarms are known which start a playback at a predefined time, as a result of which the user is woken up.

Moreover, stereo systems are known which have an initial play function by means of which the files present on a data medium are initially played in each case for a predefined time period with subsequent automatic changeover to the next title.

### BRIEF DESCRIPTION OF THE DRAWINGS

Example of the disclosed embodiments are described in detail below with reference to the accompanying drawings. In the drawings:

FIG. 1 is a schematic view of components of an example embodiment of a playback device as a component of an example embodiment of a means of transport;

FIG. 2 is a schematic view of components of an alternative example embodiment of a media playback device that is a tablet PC;

FIG. 3 is a first screen view illustrating a possible arrangement of display elements for defining a timeline;

FIG. 4 is a second screen view to illustrate an alternative design of a timeline; and

FIG. 5 is a flow diagram illustrating steps of an example embodiment of a method.

### DETAILED DESCRIPTION OF THE DISCLOSED EMBODIMENTS

Disclosed embodiments provide method for preparing a playback of different media via a media playback device. To do this, a first user input is received in a first step for predefining a first time period for the playback of first media content having first characteristics. In other words, the user defines an absolutely or relatively (e.g. from the start of the playback) defined time period over which he would like to consume the first media content. A second user input is then received for predefining an automatic playback of second media content having second characteristics following an expiry of the first time period. In other words, the user already defines a time-controlled changeover to media content having second characteristics before the end of the first time period. A temporal sequence predefined in this way is intended to be designated as a “timeline” in the context of the present disclosure. Here, the user does not necessarily define a quite specific content, as is customary when a music title is added to a playlist. The first media content or the first characteristics may after all designate a radio program, a radio station or the like that the user wishes to consume for a first predefined time period. Instead, independently from the selection of the media content, the focus is on the specific time period in the definition in such a way that the first user input can also be restricted exclusively to the definition of the time period and only then is the first media content having first characteristics defined. A value can also be predefined for the time period which is confirmed or adjusted by the user. According to the present disclosure, a changeover of a played back media content is therefore predefined by the user for a specific future time before the playback of the first media content has been ended, in particular before it has been started. A timeline defined in this way may, for example, be stored, named, linked to predefined events or activated/started via a predefined user gesture. In this way, time periods can be predefined for the consumption of information having specific characteristics without the user in each case having to add content already known to him from a media data memory to a playlist. In this way, the user can flexibly compile time windows for infotainment content without the specific signals necessarily being the same for each repeated use of the timeline. As a result, the method ensures the consumption of media content having different characteristics within a predefined time period, although the content does not yet need to be defined at the time when the timeline is created.

During the second user input or a third user input, a second time period can also be predefined for the playback of the second media content having second characteristics. In other words, a time period is defined following the end of the playback of the first media content, the time period being automatically filled by the playback of the second media content.

Accordingly, following the second time period, a changeover of the audio signals can be predefined by a fourth user input in such a way that a third media content having third characteristics (which may, for example, but does not have to be, identical to the first media content having first characteristics) is then played back.

For example, the timeline predefined in this way can be started by the reception of a further user input. As will be described below, different events can alternatively or additionally start the playback of the timeline. The time periods may be identical or (partially) different.

To prevent a sudden source changeover (e.g. in the middle of a song, film, program or the like), it can be recognized automatically that the first or each subsequent predefined time period has elapsed, but a currently played back program of the media content concerned has not yet ended. In response to this, the first time period can be extended once until the end of the currently played back program. In other words, the end of the currently played back program is first awaited before the second media content having second characteristics is played back. In particular, however, an immediate playback of the second media content can be automatically initiated provided that the complete playback of the currently played back program equates to an extension of the first time period by a value above a predefined threshold value. Depending on the currently played back source, this information may already be present at the end of the first predefined time period (e.g. if the second media content is a locally stored title). Alternatively, information (e.g. meta information similar to the VPS signal) which, for example identifies the end of a radio program, a film or the like can be awaited. Provided that it is recognized at the end of the first predefined time period that even an extension of the first predefined time period by a predefined threshold value cannot prevent an interruption of the currently played back program, a changeover can already be effected at the end of the first predefined time period or only on expiry of the extension for the playback of the second media content to avoid unnecessarily confusing the temporal sequence.

Optionally, extended time periods can be compensated for in such a way that the respective immediately adjoining subsequent time period is shortened once by a corresponding time period. Similarly, a shortening of all later time periods by a respective fraction can be undertaken to compensate for the extension. Alternatively, the extensions can result in a corresponding extension of the total time period of the timeline, so that the time periods following the extended time period are retained unchanged.

The first and second media contents may differ from one another by different characteristics. Here, the media contents may differ from one another in respect of one characteristic or in respect of a plurality of characteristics. At least the changeover of one characteristic is provided. For example, one of the media contents may be a radio station. Alternatively or additionally, a media content may be associated with a specific radio field or a specific radio genre and may differ hereby from the second media content. A program format or the title of a stored (audio or video) media content may entail characteristics by which the media contents differ from one another. Particularly in the case of stored media content, the media content can be defined by a common performer or a common genre. Further characteristics may be traffic news/traffic radio, weather forecast, spoken programs (“Talk”), entertainment (“Comedy”), reports or background reporting and sports news. In other words, a first media content may have one of the aforementioned characteristics, whereas a media content defined for the subsequent playback does not have this characteristic.

In particular, a source changeover from a first source as a first characteristic to a second source as a second characteristic can be undertaken at a predefined time (e.g. at the end of the first time period or at the beginning of the second time period). In particular, this relates to the changeover from a playback of stored content to a radio program (or vice versa).

To design the creation and operation of the timeline as simply as possible, a timeline can initially be displayed on a display device (e.g. a screen) which is configured to be operated via gestures of the user. A display element representing media content having first characteristics and further display elements representing media content having second characteristics can then be displayed on the display device and can be moved, shortened or lengthened by a user (e.g. by means of a swiping gesture) on the timeline. Depending on the target position of the gesture on the timeline, a predefined time period which, for example, has been previously defined by the user or can subsequently be defined/adjusted is allocated to the media content added in this way. To do this, for example, movable bars can demarcate the target position in relation to earlier times/later times and can thus enable a simple and intuitive design of the timeline.

A created timeline can be stored and represented by a display element shown on a display unit. If the user selects the display element, the media playback can be started according to the associated timeline or the display element/timeline can be renamed.

To eliminate the need for a manual selection of the timeline, a location and/or a journey direction and/or a journey destination and/or a date and/or a day of the week and/or a time of day and/or a seat occupancy configuration can be allocated to the timeline. An allocation of this type may, for example, be undertaken automatically on the basis of circumstances prevailing at the time when the timeline was created. In particular, considering similar circumstances, a repeated selection of the timeline may instigate an automatic proposal to activate the timeline and, with a repeatedly accepted proposal, optionally an automatic starting of the timeline. In other words, a self-learning function is proposed with which an automated use of the timeline is effected on the basis of associated circumstances. To do this, conditions (location, journey direction, journey destination, etc.) prevailing when a media playback device configured is used can be verified and compared with the circumstances allocated to the timeline. If a predefined measure of correspondence is achieved, the timeline is started and the first media content is thus played back for the first time period until, following expiry of the time period, the second media content is automatically played back.

For the simplified creation of a timeline, such a timeline can be defined on any given input device and can then be transmitted (e.g. through the mediation of the Internet and/or through the mediation of a wireless communication connection) to a media playback device equipped according to the present disclosure and/or a means of transport. Corresponding timelines can also be stored in a database and/or in a profile of a social network and can be made available to other users. This avoids a creation of each timeline by a respective user and enables an increase in the level of awareness of media content contained therein.

According to a second disclosed embodiment, a media playback device is proposed which is configured to carry out a method. The media playback device may be a user terminal device essentially restricted to the consumption of media content. In particular, it is not configured to edit media content and does not create a new data file containing audio or video signals. The media playback device may be designed as a wireless communication device (e.g. a smartphone, tablet PC or the like). The media playback device may be provided as a component of a means of transport (e.g. as a component of an infotainment system of an automobile). The media playback device comprises a signal input for receiving media content. The signal input may be configured, for example, for radio reception or for the reception of stored media files. Furthermore, an audio processor is provided for generating audio signals based on the media content. The audio processor may comprise, for example, a digital/analog (D/A) converter. A signal output is configured to output the audio signals (if necessary preamplified). A user can perform inputs via an input unit to define the timeline that is to be created according to the method described above.

Via a display device, the media playback device can display a configurable timeline that visualizes a first time period for the playback of the first media content and a second time period for the playback of the second media content. The timeline may, for example, have differently colored segments that can be lengthened or shortened by means of movable boundaries. The media playback device may furthermore be configured to receive datasets representing timelines via a wireless connection and use/store them for the playback of media content.

According to a third disclosed embodiment, a computer program product (e.g. a data memory) is proposed on which instructions are stored which enable a programmable processor of a media playback device to carry out the steps of a method according to the first disclosed embodiment. The computer program product may be designed as a CD, DVD, Blu-ray disc, flash memory, hard disk, RAM/ROM, cache, etc.

According to a fourth disclosed embodiment, a signal sequence is proposed representing instructions which enable a programmable processor of a media playback device to carry out the steps of a method according to the first disclosed embodiment. In this way, the provision through information technology of the instructions is protected for the case where the storage means required for this purpose fall outside the scope of the attached claims.

According to a fifth disclosed embodiment, a means of transport (e.g. a vehicle, an aircraft, an automobile, a transporter, a truck, a land and/or water vehicle) is proposed which comprises a media playback device according to the second disclosed embodiment. The media playback device may be a component of an infotainment system permanently integrated into the means of transport (in particular a head unit). In particular, characteristics allocated to the timeline or positions of the means of transport, seat occupancy situations, etc. can be recognized via sensors of the means of transport and the playback of the timeline can be started provided that corresponding characteristics are allocated to the timeline. The features and feature combinations resulting therefrom clearly correspond to those of the first disclosed embodiment in such a way that reference is made to the above descriptions to avoid repetitions.

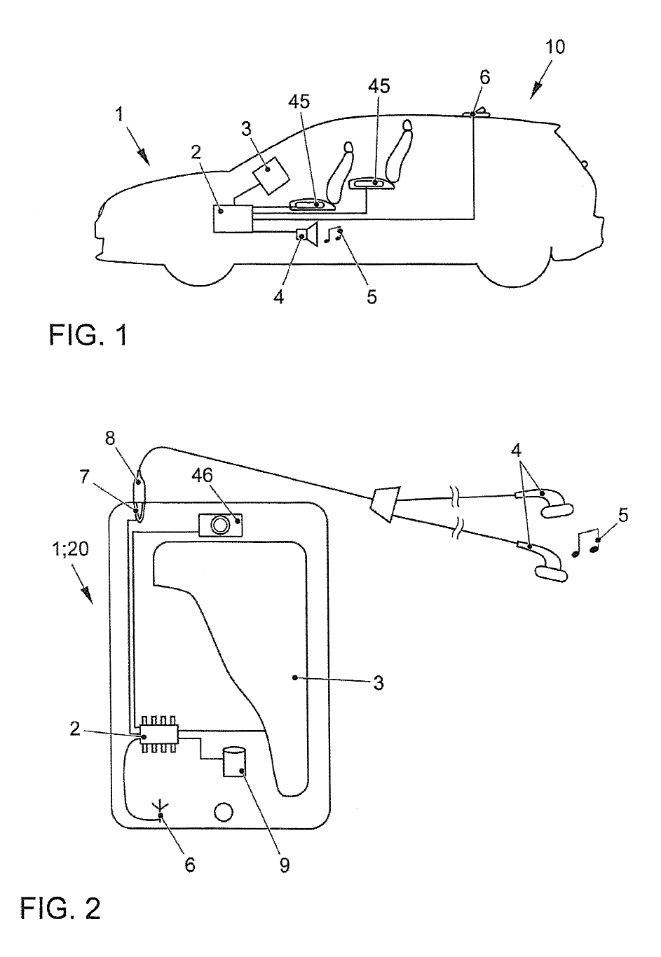

FIG. 1 shows an automobile 10 as a means of transport in which an infotaimnent system 1 designed according to the disclosed embodiments is provided as a media playback device. A touchscreen 3 as an input unit and display device for displaying and operating the timeline is connected using information technology to an electronic control device 2 as an (audio) processor. Further inputs of the electronic control device 2 are connected using information technology to mats 45 for seat occupancy recognition and to an antenna 6 for receiving wirelessly communicated datasets representing timelines created according to the disclosed embodiments. A loudspeaker 4 symbolizes a signal output for outputting the audio signals 5 which are allocated to the media content. A reception, additionally enabled with the antenna 6, of satellite-based signals enables a location and journey direction determination. Information allocated to the timelines can be compared with the position and seat occupancy information and the most closely corresponding timeline can be proposed or used automatically for the playback.

FIG. 2 shows a media playback device 1 designed in a tablet PC 20 which is connected via an (audio) processor 2, a 3.5 mm jack 7 as a signal output, a camera 46 to recognize faces allocated to a timeline, an antenna 6 for satellite-based location and for receiving wirelessly communicated datasets representing timelines, a data memory 9 and a touchscreen 3 as an input unit and display device. A 3.5 mm jack plug 18 which is connected to headphones 4 to convert the audio signals into sound signals 5 is inserted into the 3.5 mm jack output 7. Persons allocated to the timelines stored in the data memory 9 can be recognized once more via the camera 46 for facial recognition and a playback of a timeline of this type can be proposed or automatically activated if the current user has a predefined measure of correspondence with the allocated information.

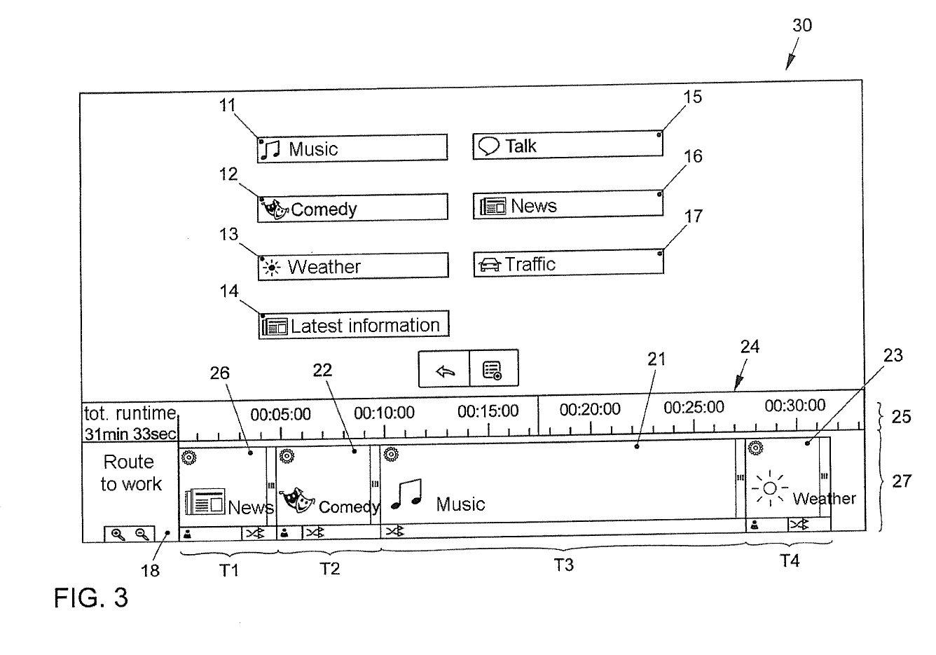

FIG. 3 shows a screen view 30 on which has a multiplicity of display elements for defining a content of a timeline 24, comprising a timeline 25 and a content area 27 representing media content. A button 11 is provided to define a media content comprising musical content. A user gesture (not shown), such as a typing gesture or swiping gesture can produce the result that a predefined time range T3 is provided within the timeline 24 for the music playback and is provided with a movable bar 21 for this purpose. A second button 12 for adding comedic content to a predefined time area T2 may be a bar 22, a third button 13 for adding a time period T4 for weather reports may be a bar 23, a fourth button 14 for defining a time window (not shown) for the playback of current information, a fifth button 15 for adding talk content, a sixth button 16 for adding a time window T1 for the playback of news represented by a bar 26, and a seventh button 17 for defining a time window (not shown) comprising traffic news are provided accordingly. In this way, a timeline 24 characterized with a title 18 “Route to work” can entertain a user for almost 32 minutes (see timeline 25) with media content having different characteristics and time periods (T1, T2, T3, T4) without the user having to perform the respective genre changeover or source changeover manually. The beams 21, 22, 23, 26 shown within the content area 27 are demarcated from one another by colors, wherein the display elements 11 to 17 citing coloration are used to simplify a visual allocation for the user.

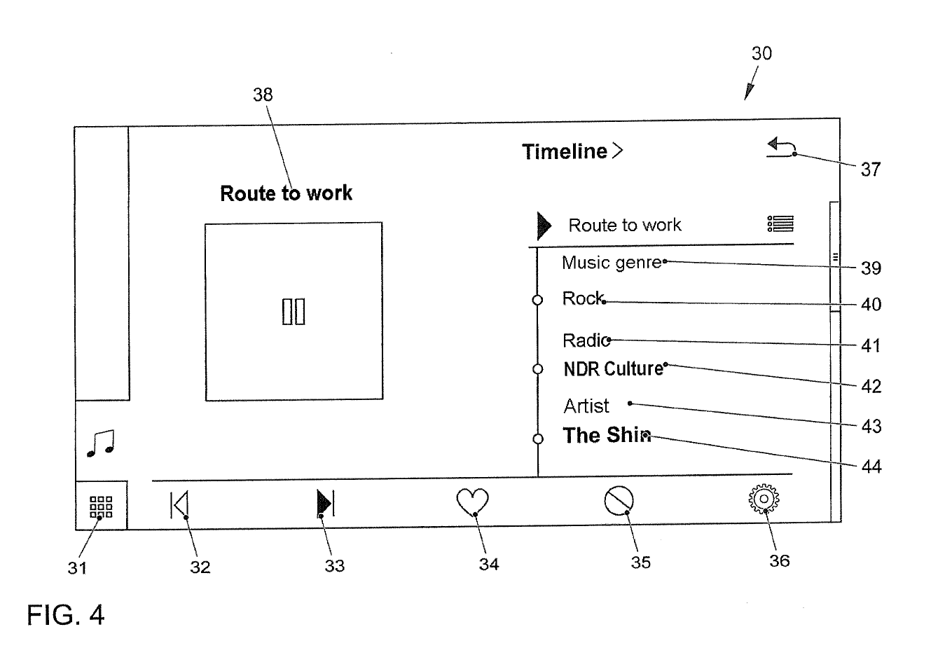

FIG. 4 shows an alternative screen representation 30 by means of which a played back timeline can be designated with the title 38 “Route to work” and can be operated. From top to bottom, the timeline consists of the music genre 39 “Rock” 40, a subsequent playback of the station 42 “NDR Culture” from the source 41 “Radio”, after which a specific artist 43 by the name of “The Shin” 44 is played back from a local data memory. A button 37 enables the exit from the displayed representation. A button 31 enables a parallel presentation of a plurality of screen contents. Via a button 32, it is possible to return to the previously played back media content, via a button 33 it is possible to jump to a next media content. A previous/following program having the same characteristics/the same media content can be selected via these buttons 32, 33. If the button 33 is pressed several times in quick succession, the entire currently played back media content will be skipped, even if the time period provided for it has not yet expired. This enables a flexible operation and adaptation of timelines. A heart symbol 34 enables the definition of a favorite for subsequent simplified selection, a further symbol 35 enables the deletion of a currently played back media content from the timeline presented and a symbol 36 enables the activation of a search function with the current media content for stylistically related media content.

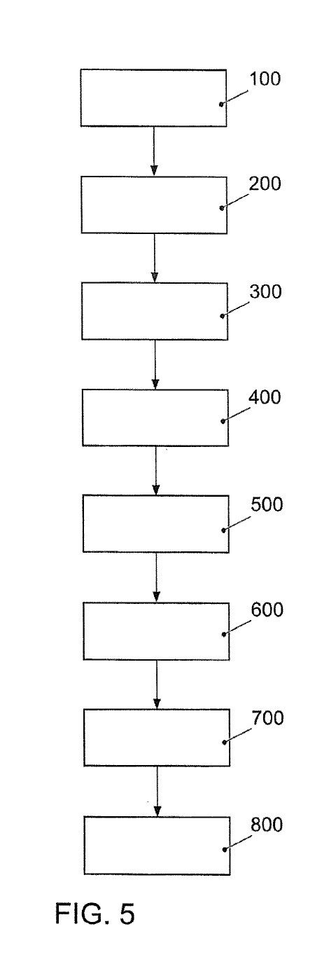

FIG. 5 illustrates steps of an example embodiment of a method for preparing a playback of different media via a media playback device. In step 100, a first user input is received for predefining a first time period for the playback of first media content having first characteristics and, in step 200, a second user input is received for predefining an automatic playback of second media content having second characteristics following an expiry of the first time period. In step 300, a third user input is received for predefining a second time period for the playback of the second media content. In step 400, a fourth user input is received for the predefinition and automatic repeat input of third media content having third characteristics following an expiry of the second time period. In step 500, the playback of the first media content within the timeline defined above is started. In step 600, it is recognized that, although the first predefined time period has elapsed, it is nevertheless recognized in step 700 that a currently played back program of the first media content has not yet ended. To avoid a sudden interruption of the playback of the program and to ensure the complete playback of the meaningful unit, the first time period is extended in step 800 until the end of the currently played back program, before the second media content is subsequently played back.

The creation of timelines enables users to define a specific sequence of media content on a one-off basis. This sequence can then be played as often as required (e.g. daily on the journey to work) by means of a single click or the like. The individual contents do not have to be selected manually. In contrast to a simple playlist, a timeline is generated dynamically. This means that the user incorporates, for example, the element “News” into his timeline, but a permanently defined program is not stored as a result, but rather the latest news available to the system is always played back. For example, a radio station can be selected automatically for this purpose, provided that meta information gives an indication that the station is currently transmitting news. As a result, timelines to some extent offer the facility for a user to compile his own “radio program” with content of interest to him (in each case with the required sequence and required length). For example, timelines can be created or configured via a portal that is a web page. Datasets representing timelines can be exchanged among different users, and can be evaluated, dispatched and provided with comments or personal messages. For example, recommendations in a media-related application can always refer to programs that match a currently played back media content. However, programs from the category or programs having characteristics that have been defined as following in the timeline may be displayed in the recommendations as from the time when the defined end of the time period is reached.

Timelines created may contain elements from different media sources (e.g. music from the dedicated database, radio and podcasts). When using the timeline, the user does not have to decide which media source is currently of most interest to him. The timeline defines the content dynamically within wide boundaries. This means that static content is not defined as in a conventional playlist, but merely boundary conditions are defined for selected time periods, depending on which, where appropriate, content (files or content of radio programs) that has been updated in the interim is played back.

Even if the disclosed embodiments have been described in detail with reference to the attached drawing figures, modifications and combinations of features of the presented example embodiments are possible for the person skilled in the art without leaving the domain of the present disclosure, the scope of protection of which is defined by the attached claims.

Users of media during participation in road traffic usually have specific preferences and listening habits relating to the media content that they listen to on a specific route. This may involve, for example, the following temporal sequence: 1. Traffic information, 2. News, 3. Comedy programs, 4. Live radio program, or 5. Talking books/longer reports/background reports. The specific sequence of media content is often repeated on a daily basis. For example, the user wishes for a corresponding playback sequence on the daily route to work.

In the prior art, radio alarms are known which start a playback at a predefined time, as a result of which the user is woken up.

Moreover, stereo systems are known which have an initial play function by means of which the files present on a data medium are initially played in each case for a predefined time period with subsequent automatic changeover to the next title.

EP 1 939 880 B1 discloses a method of controlling a vehicle infotainment system with personalized content in which a playlist can be created and selected by the user on the basis of a music recognition value which represents a specification for specific listening opportunities . Different sources may be contained in the playlist.

U.S. Pat. No. 8,634,944 B2 discloses a system for analyzing available audio content and radio programs so that the user can switch between the content depending on his preferences or can create a playlist from the content. An event-dependent changeover from the playback of a first content to the playback of a second content is also proposed.

For many situations, approaches known in the prior art are too complex for a user. Moreover, the known approaches lag behind the theoretically possible functional capabilities. Disclosed embodiments eliminate the disadvantages identified above.

### REFERENCE NUMBER LIST

1 Infotainment system/media playback device
2 Electronic control device
3 Touchscreen
4 Loudspeaker
5 Audio signals
6 Antenna
7 3.5 mm jack socket
8 3.5 mm jack plug
9 Data memory
10 Automobile
11-17 Display elements
18 Title of the timeline
20 Tablet PC
21-23, 26 Bars
24 Timeline
25 Timeline
27 Content range
30 Screen view
31-37 buttons
38 Title
39 Music genre
40 Selected genre
41 “Radio” source
42 Station name
43 Artist
44 Name of the artist
45 Mats for seat occupancy recognition
46 Optical camera
100-800 Method steps
T1-T4 Time period

1. A Method for preparing a playback of different media via a media playback device, the method comprising:
receiving a first user input for predefining a first time period for the playback of first media content having first characteristics,
receiving a second user input for predefining an automatic playback of second media content having second characteristics following an expiry of the first time period,
recognizing that the first predefined time period has expired,
recognizing that a currently played back program of the first media content has not yet ended, and, in response to this,
extending the first time period until the end of the currently played back program, and, in particular, and
immediately playing back the second media content, provided that the complete playback of the currently played back program equates to an extension of the first time period by a value above a predefined threshold value.

2. The method of claim 1, further comprising:
receiving a third user input for predefining a second time period for the playback of the second media content.

3. The method of claim 2, further comprising:
receiving a fourth user input for predefining an automatic playback of third media content having third characteristics following an expiry of the second time period.

4. The method of claim 1, further comprising:
starting the playback of the first media content.

5. The method of claim 1, wherein the first characteristics and/or the second characteristics correspond to different entries in the following list:
Radio station
Radio field or radio genre
Program format
Title of a stored media content
Performer of a stored media content
Genre of stored media content
Traffic radio
Weather forecast
Comedy
Spoken programs
Reports/background reporting
Sport

6. The method of claim 1, wherein the first characteristics represent a first source and/or the second characteristics represent a second source.

7. The method of claim 1, wherein the first characteristics represent a first genre and/or the second characteristics represent a second genre.

8. The method of claim 1, further comprising:
displaying a timeline on a display device,
receiving a swiping gesture of the user in relation to a display element,
recognizing that a target position of the swiping gesture of the user is on the timeline, and, in response to this,
defining the first time period for the playback of the first media content having first characteristics.

9. The method of claim 1, further comprising:
storing the prepared playback of different media,
presenting a display element,
receiving a user input relating to the display element, and, in response to this,
playing back the first media content for the first time period and subsequently playing back the second media content.

10. The method of claim 1, further comprising:
storing a location and/or a journey direction and/or a journey destination and/or a date and/or a day of the week and/or a time of day and/or a seat occupancy configuration for the prepared playback,
comparing a current location and/or a current journey direction and/or a current journey destination and/or a current date and/or a current time of day and/or a current seat occupancy configuration with a corresponding memory content stored for the prepared playback, and, in response to a predefined measure of a correspondence,
playing back the first media content for the first time period and subsequently playing back the second media content.

11. The method of claim 1, further comprising:
transmitting a dataset representing the prepared playback to a means of transport.

12. Media A media playback device, comprising:
a signal input for receiving media content,
an audio processor for generating audio signals based on the media content,
a signal output for outputting the audio signals, and
an input unit for receiving user inputs, wherein the media playback device
is configured to carry out a method for preparing a playback of different media via the media playback device, the method comprising receiving a first user input for predefining a first time period for the playback of first media content having first characteristics, receiving a second user input for predefining an automatic playback of second media content having second characteristics following an expiry of the first time period, recognizing that the first predefined time period has expired,
recognizing that a currently played back program of the first media content has not yet ended, and, in response to this,
extending the first time period until the end of the currently played back program, and, in particular, and
immediately playing back the second media content, provided that the complete playback of the currently played back program equates to an extension of the first time period by a value above a predefined threshold value.

13. The media playback device of claim 11, further comprising a display device which is configured to display a configurable timeline which visualizes a first time period for the playback of the first media content and a second time period for the playback of the second media content.

14. A computer program product, comprising instructions or a signal sequence representing instructions which, if they are executed on a programmable processor of a media playback device according to claim 12.

15. A means of transport, comprising the media playback device of claim 12.
